(19) United States
(12) Patent Application Publication
(10) Pub. No.: US 2018/0277880 A1
(43) Pub. Date: Sep. 27, 2018

(54) NONAQUEOUS ELECTROLYTE SECONDARY BATTERY

(71) Applicant: Sanyo Electric Co., Ltd., Osaka (JP)

(72) Inventors: Takashi Hosokawa, Hyogo (JP); Hidekazu Tamai, Kyoto (JP); Taiki Nonaka, Hyogo (JP)

(73) Assignee: Sanyo Electric Co., Ltd., Osaka (JP)

(21) Appl. No.: 15/908,929

(22) Filed: Mar. 1, 2018

(30) Foreign Application Priority Data
Mar. 27, 2017 (JP) 2017-061807

(51) Int. Cl. H01M 10/04; H01M 10/0587; H01M 2/02

(52) U.S. Cl. CPC H01M 10/0431; H01M 2/02; H01M 10/0587

(57) ABSTRACT

A flat wound electrode assembly formed by winding a positive electrode plate and a negative electrode plate together with a separator interposed therebetween is used. The number of stacked layers of the positive electrode plate in the wound electrode assembly is 50 or more. The total thickness of the separator is 10% or less of the thickness of the wound electrode assembly in a thickness direction of the layers of the wound electrode assembly. A value obtained by dividing the local breaking elongation of the separator by the thickness of the separator is 0.16 or more. A value obtained by dividing the local breaking strength of the separator by the thickness of the separator is 2.77 or more.

### CROSS REFERENCE TO RELATED APPLICATIONS

The present invention application claims priority to Japanese Patent Application No. 2017-061807 filed in the Japan Patent Office on Mar. 27, 2017, the entire contents of which are incorporated herein by reference.

### BACKGROUND OF THE INVENTION

### Field of the Invention

The present disclosure relates to a nonaqueous electrolyte secondary battery.

### Description of Related Art

A nonaqueous electrolyte secondary battery disclosed in Japanese Published Unexamined Patent Application No. 2012-33334 (Patent Document 1) has been used. This nonaqueous electrolyte secondary battery includes a flat electrode assembly that is formed by winding a positive electrode plate and a negative electrode plate together with a separator interposed therebetween. The positive electrode plate has a belt-shaped positive electrode substrate having a positive electrode active material layer on both sides of the positive electrode substrate, and a positive-electrode-substrate exposed portion where the positive electrode substrate is exposed in a band shape is disposed on one end portion in a width direction on both of the sides of the positive electrode substrate. The negative electrode plate has a belt-shaped negative electrode substrate having a negative electrode active material layer on both sides of the negative electrode substrate, and a negative-electrode-substrate exposed portion where the negative electrode substrate is exposed in a band shape is disposed on the other end portion in a width direction on both of the sides of the negative electrode substrate. Each of the positive electrode active material layer and the negative electrode active material layer has a structure that can intercalate and deintercalate lithium ions.

Furthermore, the nonaqueous electrolyte secondary battery includes a positive electrode current collecting member electrically connected to the positive-electrode-substrate exposed portion, a negative electrode current collecting member electrically connected to the negative-electrode-substrate exposed portion, a nonaqueous electrolyte, an outer body, and a sealing body. The electrode assembly is inserted into the outer body and the nonaqueous electrolyte is enclosed in an outer case made by sealing an opening of the outer body by using the sealing body.

The positive electrode current collecting member is electrically connected to a positive electrode terminal, and the negative electrode current collecting member is electrically connected to a negative electrode terminal.

A nonaqueous electrolyte secondary battery for vehicles employing a flat wound electrode assembly requires a higher capacity. To achieve a higher capacity of the nonaqueous electrolyte secondary battery, in addition to increasing the number of windings of the electrode plate, increasing the thickness of the active material layers and reducing the thickness of the separator may be performed. However, a wound electrode assembly with such a structure expands considerably during charge-discharge cycles.

The present inventors have found that when a flat wound electrode assembly expands considerably, a high tensile stress is generated in a winding direction in a boundary region between a flat portion and a curved portion of the flat wound electrode assembly. The present inventors confirmed that not only electrode plates but also a separator may break in the periphery of the boundary region, and as a result, the positive electrode and the negative electrode may be short-circuited.

In a secondary battery for vehicles employing a flat wound electrode assembly, the number of windings increases with increasing the capacity compared with batteries for general use. This increases deformation caused by expansion and contraction of the positive and negative electrode active materials during charge and discharge of the battery.

The present inventors have found that the deformation is particularly notable in a high-capacity battery in which the thickness of positive and negative electrode plates is relatively increased and the thickness of a separator is reduced, and that a high tensile stress is generated in a winding direction in a boundary region between a flat portion and a curved portion of a flat electrode assembly. The present inventors have confirmed that not only the electrode plates but also the separator may break in the periphery of the boundary region, and as a result, the positive electrode and the negative electrode may be short-circuited.

### BRIEF SUMMARY OF THE INVENTION

An object of the present disclosure is to provide a nonaqueous electrolyte secondary battery having a separator that is unlikely to break even if a capacity is increased by reducing the thickness of the separator and increasing the number of windings.

A nonaqueous electrolyte secondary battery according to the present disclosure includes a flat wound electrode assembly formed by winding a positive electrode plate and a negative electrode plate together with a separator interposed therebetween, an outer case including an outer body in which the wound electrode assembly is disposed and a sealing body that seals an opening of the outer body, a positive electrode current collector electrically connected to the positive electrode plate, a negative electrode current collector electrically connected to the negative electrode plate, and a nonaqueous electrolyte disposed in the outer case. A number of stacked layers of the positive electrode plate in the wound electrode assembly is 50 or more. The separator has a total thickness of 10% or less of a thickness of the wound electrode assembly in a thickness direction of the layers in the wound electrode assembly. With regard to a first test specimen, a second test specimen, and a third test specimen, all of which are made of a material identical to a material for the separator and have a thickness identical to a thickness of the separator and a width of 40 mm, the first test specimen having a length of 1 mm in a winding direction, the second test specimen having a length of 3 mm in the winding direction and only length being a difference between the first and second specimens, and the third test specimen having a length of 5 mm in the winding direction and only length being a difference between the first and third specimens, in a test in which a length (mm) of each of the three test specimens is measured to obtain three measuring points at which the test specimen breaks while being pulled in the winding direction, in a two-dimensional plane where one parameter denotes a length of the test specimen in the winding direction before the test and another parameter denotes the length measured when the test specimen breaks while being pulled in the winding direction, when an intersection point of a linear function obtained by a least squares method in accordance with the three measuring points of the first to third test specimens and an axis of the other parameter is defined as a local breaking elongation of the separator, a value obtained by dividing the local breaking elongation of the separator by the thickness of the separator is 0.16 or more. With regard to the first to third test specimens, in a test in which a strength (N/cm) of each of the three test specimens is measured to obtain three measuring points at which the test specimen breaks while being pulled in the winding direction, in a two-dimensional plane where one parameter denotes a length of the test specimen in the winding direction before the test and another parameter denotes strength measured when the test specimen breaks while being pulled in the winding direction, when an intersection point of a linear function obtained by the least squares method in accordance with the three measuring points of the first to third test specimens and an axis of the parameter denoting the strength measured when the test specimen breaks is defined as a local breaking strength of the separator, a value obtained by dividing the local breaking strength of the separator by the thickness of the separator is 2.77 or more.

A high capacity can be achieved in the nonaqueous electrolyte secondary battery according to the present disclosure by increasing the number of windings and reducing the thickness of a separator, and the separator is unlikely to break.

### BRIEF DESCRIPTION OF THE SEVERAL VIEWS OF THE DRAWINGS

FIG. 1A is a plan view of a prismatic secondary battery that can be manufactured by a method according to the present disclosure, and FIG. 1B is a front view of the prismatic secondary battery.

FIG. 2A is a fragmentary cross-sectional view taken along line IIA-IIA in FIG. 1A, FIG. 2B is a fragmentary cross-sectional view taken along line IIB-IIB in FIG. 2A, and FIG. 2C is a cross-sectional view taken along line IIC-IIC in FIG. 2A.

FIG. 3A is a plan view of a positive electrode plate included in the prismatic secondary battery, and FIG. 3B is a plan view of a negative electrode plate included in the prismatic secondary battery.

FIG. 4 is a perspective view of a flat wound electrode assembly included in the prismatic secondary battery, with the winding end of the electrode assembly unwound.

FIGS. 5A, 5B, and 5C respectively illustrate first, second, and third specimens employed in a measurement for calculating the local breaking elongation and local breaking strength of a separator included in the prismatic secondary battery.

FIG. 6 is a graph illustrating an example of three measuring points of the first, second, and third test specimens in a two-dimensional plane, where one parameter denotes the length in a winding direction of the test specimen before a test and the other parameter denotes the length of the test specimen measured when the test specimen breaks while being pulled in the winding direction.

FIG. 7 is a graph illustrating an example of three measuring points of the first, second, and third test specimens in a two-dimensional plane, where one parameter denotes the length in a winding direction of the test specimen before a test and the other parameter denotes a breaking strength measured when the test specimen breaks while being pulled in the winding direction.

FIG. 8 is a plan view of a test specimen employed in typical measurement of breaking elongation and breaking strength.

FIG. 9 illustrates measuring points of Example and Comparative examples 1 to 3 in a two-dimensional plane, where the x-axis parameter denotes a typical breaking elongation and the y-axis parameter denotes a local breaking elongation.

FIG. 10 illustrates measuring points of Example and Comparative examples 1 to 3 in a two-dimensional plane, where the x-axis parameter denotes a typical breaking strength and the y-axis parameter denotes a local breaking strength.

FIGS. 11A to 11C are schematic plan views that partly illustrate a periphery of the wound electrode assembly and that illustrate a breaking mechanism of the positive electrode plate, the negative electrode plate, and the separator in a battery case, as considered by the present inventors.

### DETAILED DESCRIPTION OF THE INVENTION

Hereinafter an embodiment of the present disclosure will be fully described with reference to the attached drawings. However, the following embodiment will be described by way of example to facilitate an understanding of the technical idea of the present disclosure and is not intended to limit the present disclosure. For example, creating a new embodiment by appropriately combining features of the following embodiment and its modification is expected from the beginning. The present disclosure may also be equally applied to embodiments changed without departing from the technical idea disclosed in the claims.

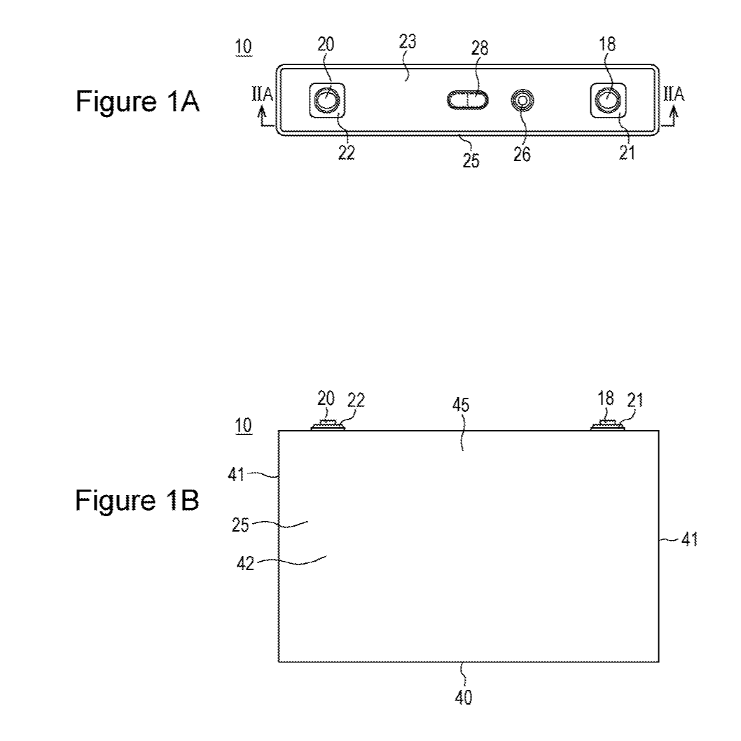

Hereinafter, with reference to FIGS. 1A to 4, an overall structure of a prismatic secondary battery 10 to which a manufacturing method of the present disclosure can be applied will be described.

As illustrated in FIGS. 1A, 1B, 2A, 2B, 2C, and 4, a prismatic secondary battery 10 serving as an example of the nonaqueous electrolyte secondary battery includes a prismatic outer body (prismatic outer can) 25, a sealing plate 23, and a flat wound electrode assembly 14. The prismatic outer body 25 is made of, for example, aluminum or an aluminum alloy and has an opening on one side in a height direction. As illustrated in FIG. 1B, the prismatic outer body 25 includes a bottom portion 40, a pair of first side surfaces 41, and a pair of second side surfaces 42. The second side surfaces 42 are larger than the first side surfaces 41. The sealing plate 23 fits an opening of the prismatic outer body 25. Joining the sealing plate 23 and the prismatic outer body 25 at a fitting portion forms a prismatic battery case 45.

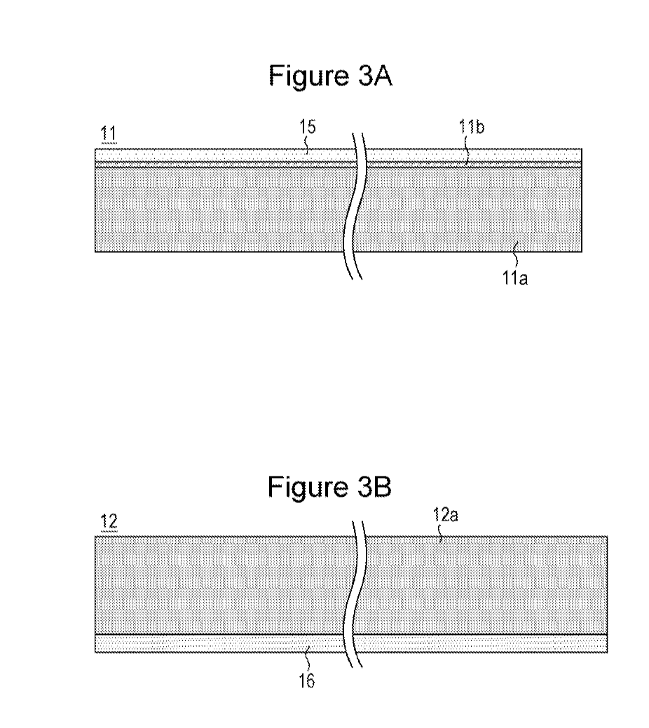

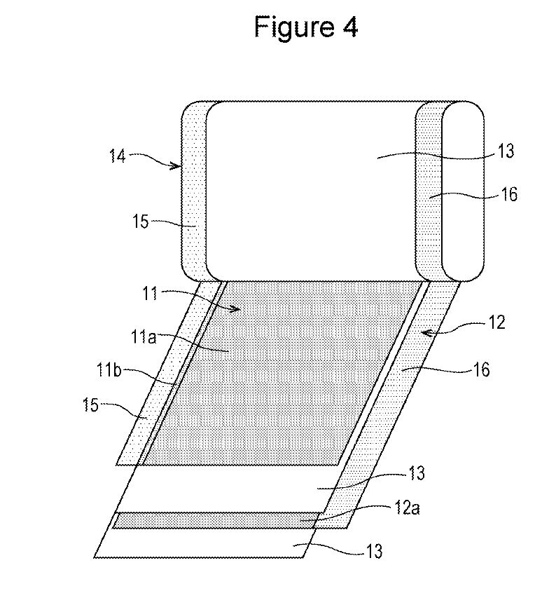

As illustrated in FIG. 4, the wound electrode assembly 14 has a structure in which a positive electrode plate 11 and a negative electrode plate 12 are wound together with a separator 13 interposed therebetween so as to be insulated from each other. The separator 13 is also disposed on an outermost side of the wound electrode assembly 14. The negative electrode plate 12 is disposed on an outer side with respect to the positive electrode plate 11. The total number of stacked layers of the positive electrode plate 11 in the flat portion of the flat wound electrode assembly 14 (hereinafter, the total number of stacked layers is defined as the number of stacked layers of the positive electrode plate) is 40 or more (i.e., the number of windings is 20 or more), preferably 50 or more (i.e., the number of windings is 25 or more), and more preferably 60 or more (i.e., the number of windings is 30 or more). Referring to FIG. 3A, the positive electrode plate 11 has a positive electrode substrate made of an aluminum foil or an aluminum alloy foil with a thickness of about 10 to 20 μm. A positive electrode mixture slurry is applied to both sides of the positive electrode substrate, and drying, rolling, and cutting into strips at a predetermined size are performed to form the positive electrode plate 11. At this point, a positive-electrode-substrate exposed portion 15 where a positive electrode mixture layer 11a is not formed is formed in one end portion in a width direction so as to extend in a longitudinal direction on both surfaces of the positive electrode plate 11. On at least one of the surfaces of the positive-electrode-substrate exposed portion 15, a positive electrode protecting layer 11b is preferably formed in a longitudinal direction of the positive-electrode-substrate exposed portion 15, for example, so as to be adjacent to the positive electrode mixture layer 11a. The positive electrode protecting layer 11b includes insulating inorganic particles and binders. The positive electrode protecting layer 11b has lower electrical conductivity than the positive electrode mixture layer 11a. Forming the positive electrode protecting layer 11b can prevent a short circuit caused by foreign particles and the like between a negative electrode mixture layer 12a and the positive electrode substrate. The positive electrode protecting layer 11b may also include conductive inorganic particles. As a result of this, even if a short circuit between the positive electrode protecting layer 11b and the negative electrode mixture layer 12a occurs, a small internal short-circuit current can continue to flow, thereby placing the prismatic secondary battery 10 into a safe state. The electrical conductivity of the positive electrode protecting layer 11b can be controlled by changing a mixture ratio of the conductive inorganic particles and the insulating inorganic particles. The positive electrode protecting layer 11b is not necessarily formed.

Referring to FIG. 3B, the negative electrode plate 12 has a negative electrode substrate made of a copper foil or a copper alloy foil with a thickness of about 5 to 15 μm. A negative electrode mixture slurry is applied to both surfaces of the negative electrode substrate, and drying, rolling, and cutting into strips at a predetermined size are performed to form the negative electrode plate 12. At this point, a negative-electrode-substrate exposed portion 16 where a negative electrode mixture layer 12a is not formed is formed so as to extend in a longitudinal direction on both surfaces of the negative electrode plate 12. The positive-electrode-substrate exposed portion 15 and the negative-electrode-substrate exposed portion 16 may be formed along both end portions in a width direction of the positive electrode plate 11 and along both end portions in a width direction of the negative electrode plate 12, respectively.

As illustrated in FIG. 4, the positive electrode plate 11 and the negative electrode plate 12 are arranged so as to be displaced in the width direction of the wound electrode assembly 14 (i.e., in the width direction of the positive electrode plate 11 and the negative electrode plate 12) with respect to the opposing electrode mixture layer 12a and the opposing electrode mixture layer 11a, respectively, so that the positive-electrode-substrate exposed portion 15 does not overlap the opposing electrode mixture layer 12a and the negative-electrode-substrate exposed portion 16 does not overlap the opposing electrode mixture layer 11a. The electrode plates are wound together with the separator 13 interposed therebetween while being insulated from each other and are formed into a flat shape, thereby producing the flat wound electrode assembly 14. The wound electrode assembly 14 includes a plurality of stacked layers of the positive-electrode-substrate exposed portion 15 in one end portion in a direction in which the winding axis extends and a plurality of stacked layers of the negative-electrode-substrate exposed portions 16 in the other end portion. The direction in which the winding axis extends matches a width direction of the band-shaped positive electrode plate 11, the band-shaped negative electrode plate 12, and the band-shaped separator 13, when each of them is rolled out in a rectangular shape.

The separator 13 is a thin film (insulating material) securing ion conductivity and separates the positive electrode from the negative electrode in the lithium ion battery. The separator 13 preferably has an innumerable number of invisibly small pores with a size of about 0.1 μm so that the ions can pass through the separator. In other words, the separator 13 holds an electrolyte in the pores and provides a passage for the lithium ions to move between the electrodes while separating the positive electrode from the negative electrode and preventing a short circuit therebetween. Preferably, the separator 13 has an important function of stopping a cell reaction to prevent excessive heat generation by melting at around 130° C. and closing of the pores. The width of the separator 13 is preferably large enough to cover the positive electrode mixture layer 11a and also larger than the width of the negative electrode mixture layer 12a.

The separator 13 is preferably thin to increase the thickness of the active material layer for the purpose of further increasing a capacity of the nonaqueous electrolyte secondary battery. Preferably, the separator 13 is thin and has a high porosity to decrease conduction resistance of the lithium ions and increase the thickness of the active material layer, thereby achieving a high capacity of the battery. For example, the separator 13 preferably has a thickness of 19 μm or less, more preferably a thickness of 16 μm or less, and most preferably a thickness of 14 μm or less.

The separator 13 further needs to have physical properties such as strong resistance to battery deformation and shock resistance to suppress with certainty a short-circuit between the positive electrode and the negative electrode. Therefore, according to the present disclosure, a value obtained by dividing the local breaking elongation of the separator 13 by the thickness of the separator 13 is 0.16 or more, and a value obtained by dividing the local breaking strength of the separator 13 by the thickness of the separator 13 is 2.77 or more.

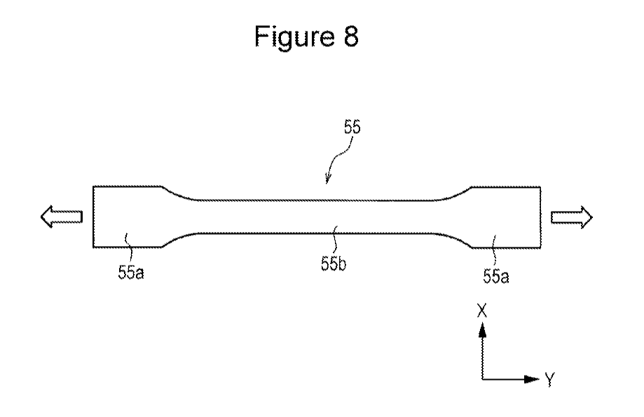

The local breaking elongation and the local breaking strength are introduced by the present inventors for the first time as an indicator of the breaking elongation and an indicator of the breaking strength of the separator 13, respectively. The separator 13 is disposed under a special condition in which the separator 13 is interposed between the positive electrode plate 11 and the negative electrode plate 12 in the wound electrode assembly 14 in the battery case. Therefore, the ease of breakage of the separator 13 cannot be correctly determined by using the breaking elongation and the breaking strength provided by JIS. The reasons why the ease of breakage of the separator 13 in the wound electrode assembly 14 cannot be determined by using the breaking elongation and the breaking strength provided by JIS and the reasons why the breaking elongation and the breaking strength of the separator in the wound electrode assembly contained in the battery case can be correctly determined by introducing the local breaking elongation and the local breaking strength, which will be described next, will be fully described later with reference to FIGS. 8 to 11C and Table 1.

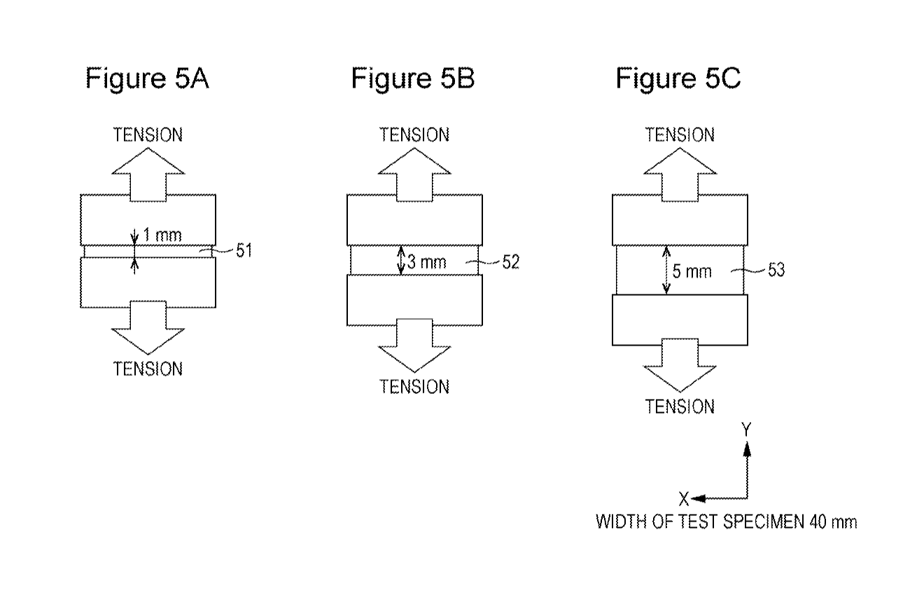

FIGS. 5A, 5B, and 5C respectively illustrate first, second, and third test specimens employed in the measurement for calculating the local breaking elongation and the local breaking strength. The first to third specimens are cut out from the separator 13 at a predetermined size. The measurement is performed using the three specimens, all of which are made of the same material as the separator 13 and have the same thickness as the separator 13 and a length (hereinafter, width) of 40 mm in a width direction that is illustrated as the X direction in FIGS. 5A to 5C. The first test specimen 51 has a length of 1 mm in a winding direction that is illustrated as the Y direction in FIGS. 5A to 5C; the second test specimen 52 has a length of 3 mm in the winding direction, the length being the only difference between the second test specimen 52 and the first test specimen 51; and the third test specimen 53 has a length of 5 mm in the winding direction, the length being the only difference between the third test specimen 53 and the first test specimen 51. The three test specimens are each cut out so that the length in the winding direction that serves as the length in the Y direction is the length of the separator 13 in the winding direction (length in a direction perpendicular to an axial direction) of the wound electrode assembly.

The measurement is performed as follows. The whole area in the width direction of one end portion in the winding direction of each of the test specimens 51 to 53 is held by a holding part of a clamp (not illustrated), and each of the test specimens is positioned accordingly. The whole area in the width direction of the other end portion is held by a holding part of a chuck (not illustrated). Then the holding part of the chuck is caused to move away from the holding part of the clump in the winding direction (Y direction). The elongation (mm) and strength (N/cm) of the test specimens 51 to 53 are measured when the test specimens break. During the measurement, the test specimens 51 to 53 are hardly contracted or not contracted in the width direction because their lengths in the winding direction are 5 mm or less, and because the holding parts of the clamp and the chuck hold the whole area in the width direction of each of the test specimens 51 to 53.

The local breaking elongation and the local breaking strength are then calculated using the results of the measurement. The local breaking elongation is calculated from three measuring points of the first test specimen 51 to the third test specimen 53 in a two-dimensional plane, where the length of the test specimen in the winding direction before the test is used as one parameter, and the length of the test specimen measured when the test specimen breaks while being pulled in the winding direction is used as the other parameter.

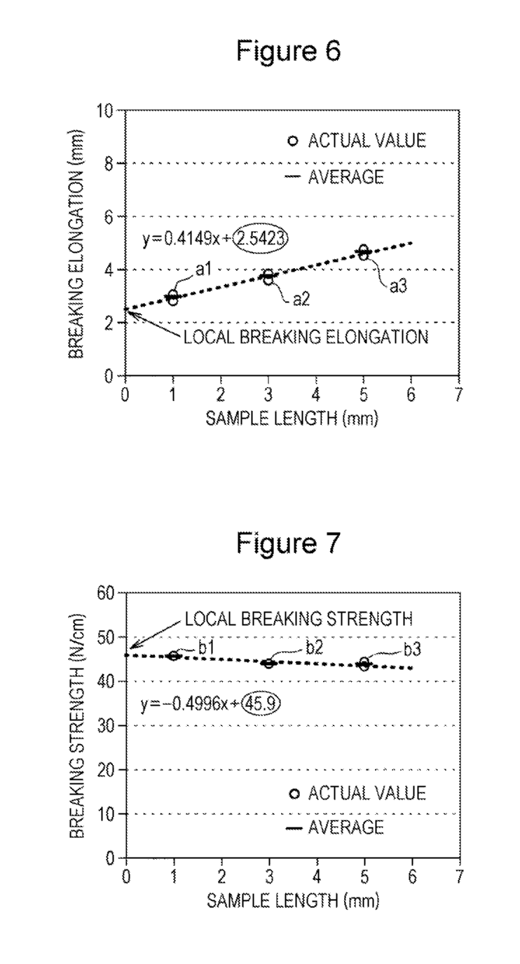

FIG. 6 is a graph illustrating an example of the three measuring points of the first to third specimens in the two-dimensional plane. In FIG. 6, the x-axis denotes the sample length that corresponds to the length of the test specimen in the winding direction before the test, and the y-axis denotes the breaking elongation that corresponds to the length of the test specimen measured when the test specimen breaks while being pulled in the winding direction. In FIG. 6, a1 is a measuring point of the first test specimen 51, a2 is a measuring point of the second test specimen 52, and a3 is a measuring point of the third test specimen 53. The measuring point of each of the test specimens 51 to 53 may be determined by using one measurement or an average of multiple measurements. In this example, the measuring point of each of the test specimens 51 to 53 is an average of three measurements of each of the test specimens 51 to 53.

After the three measuring points of the test in the two-dimensional plane are determined by using the test specimens 51 to 53, a linear function is obtained using a least squares method on the basis of the three measuring points. When the three points are on a line, the linear function corresponds to the line. In the example in FIG. 6, the linear function is expressed by Y=0.4149X+2.5423. An intersection point of the linear function and the axis denoting the other parameter, which denotes the length (mm) of the test specimen measured when the test specimen breaks is defined as the local breaking elongation of the separator 13. In the example in FIG. 6, the y-intercept of the linear function corresponds to the local breaking elongation, which is calculated to be 2.5423 mm.

Calculation of the local breaking strength will be described. The local breaking strength is also calculated from three measuring points of the first test specimen 51 to the third test specimen 53 in a two-dimensional plane, where one parameter denotes the length of the test specimen in the winding direction before the test and the other parameter denotes the breaking strength measured when the test specimen breaks while being pulled in the winding direction.

FIG. 7 is a graph illustrating an example of the three measuring points of the first to third specimens in the two-dimensional plane. In FIG. 7, the x-axis denotes the sample length that corresponds to the length of the test specimen in the winding direction before the test, and the y-axis denotes the breaking strength that corresponds to the breaking strength of the test specimen measured when the test specimen breaks while being pulled in the winding direction. In FIG. 7, b1 is a measuring point of the first test specimen 51, b2 is a measuring point of the second test specimen 52, and b3 is a measuring point of the third test specimen 53. The measuring point of each of the test specimens 51 to 53 may be determined by using one measurement or an average of multiple measurements. In this example, the measuring point of each of the test specimens 51 to 53 is an average of three measurements of each of the test specimens 51 to 53.

After the three measuring points of the test in the two-dimensional plane are determined by using the test specimens 51 to 53, a linear function is obtained by the least squares method on the basis of the three measuring points. When the three points are on a line, the linear function corresponds to the line. In the example in FIG. 7, the linear function is expressed by Y=−0.4996X+45.9. An intersection point of the linear function and the axis denoting the other parameter, which denotes the breaking strength (N/cm) of the test specimen, is defined as the local breaking strength of the separator 13. In the example in FIG. 7, the y-intercept of the linear function corresponds to the local breaking strength, which is calculated to be 45.9 N/cm.

The reason for obtaining the local breaking elongation and the local breaking strength by using the y-intercept is as follows. As the length of the test specimen in the winding direction before the test increases, the test specimen contracts further in the width direction while being pulled in the winding direction during the test. The y-intercepts, which are used to indicate the local breaking elongation and the local breaking strength, correspond to results of the measurement of a test specimen theoretically having a length of 0 mm in the winding direction before the test, and also correspond to calculated values of a test specimen that does not contract in the width direction during the test. Therefore, by using the above indicators, the breaking elongation and the breaking strength in a case where the contraction in the width direction is not allowed can be obtained. The reason why the breaking elongation and the breaking strength in the case where the contraction in the width direction is not allowed are appropriate for measuring ease of breakage of the separator 13 will be fully described later.

The physical properties such as the breaking elongation and the breaking strength of the separator 13 according to the present disclosure are evaluated with a value obtained by dividing the local breaking elongation by the thickness of the separator 13 and a value obtained by dividing the local breaking strength by the thickness of the separator 13, respectively. The reason for this is as follows. As the thickness of the separator 13 is increased, the local breaking elongation and the local breaking strength naturally increase. Therefore, the breaking elongation and the breaking strength calculated without specifying the thickness of the separator 13 are inappropriate for the evaluation of the properties (breaking elongation and breaking strength) of materials used for the separator 13. According to the method in the present disclosure, by dividing the local breaking elongation and the local breaking strength by the thickness of the separator 13, the local breaking elongation and the local breaking strength per unit thickness of the separator can be evaluated, which is appropriate as an evaluation method.

A polyolefin microporous film can be preferably used for the separator 13. As the separator 13, not only a separator made of polyethylene (PE) but also a separator made of polyethylene on the surface of which a polypropylene (PP) layer is formed or a separator made of polyethylene to the surface of which an aramid resin is applied may be used. As the separator 13, a plurality of polyethylene layers or polypropylene layers layered in the thickness direction can be suitably used. Specifically, although the separator 13 may have a three-layer structure including polypropylene layers sandwiching a polyethylene layer therebetween in a vertical direction, the separator 13 may preferably have four or more layers while including either polyethylene layers or polypropylene layers or both layers since the strength increases, more preferably six or more layers since the strength further increases notably. When the separator 13 includes nine or more layers while including either polyethylene layers or polypropylene layers or both layers, the number of interfaces each of which is produced between two layers adjacent to each other is eight or more. As the number of the interfaces increases, the strength of the separator increases and the breakage of the separator can be substantially prevented. Thus, the separator 13 most preferably includes nine or more layers. The separator 13 may be produced by a wet process (phase separation method) or a dry process (stretching method).

In the wet process, a uniform solution prepared by mixing polymers and a solvent at a high temperature is formed into a film by a T-die method, an inflation method, or the like, and the film is then formed into a microporous film constituting the separator 13 by extracting and removing the solvent by using another solvent and also by being stretched. In the wet process, the way in which the process is performed can control the porous structure, for example, by changing the combination of polymers and solvent, by selecting a stretching method from various stretching methods such as uniaxial stretching which involves roll stretching, sequential biaxial stretching which involves roll stretching and tenter stretching, and simultaneous biaxial stretching which involves biaxial tenter stretching, or by selecting a stretching condition from a case of stretching the polymer with the solvent before extraction of the solvent and a case of stretching the polymer after removal of the solvent.

On the other hand, in the dry process, a molten polymer is extruded from a T-die or a circular die, formed into a film sheet at a high draft ratio, and subjected to heat treatment to form a crystal structure with high regularity. Then a microporous film constituting the separator is produced by a process in which the crystal interfaces are delaminated by stretching the film sheet at a high temperature after stretching the film sheet at a low temperature so that gap portions are formed between lamellae, thereby forming a porous structure, or by a process in which the film sheet that is a mixture of, for example, polyethylene and polypropylene is stretched in at least one direction so that openings (micropores) at interfaces between different polymers are formed. Since the dry process does not use solvents, environment load and manufacturing costs can be reduced.

A layer containing an inorganic filler that has been used may be formed at an interface between the positive electrode plate 11 and the separator 13 and at an interface between the negative electrode plate 12 and the separator 13. As such a filler, an oxide or a phosphate compound of any one or combination of titanium, aluminum, silicon, and magnesium, which have been commonly used, or an oxide and a phosphate compound obtained by treating the surface of the above oxide and phosphate compound by using a hydroxide may be used. Examples of methods of forming such a filler layer include applying a slurry containing the filler directly to the positive electrode, the negative electrode, or the separator 13 and pasting a sheet formed with the filler on the positive electrode plate 11, the negative electrode plate 12, or the separator 13.

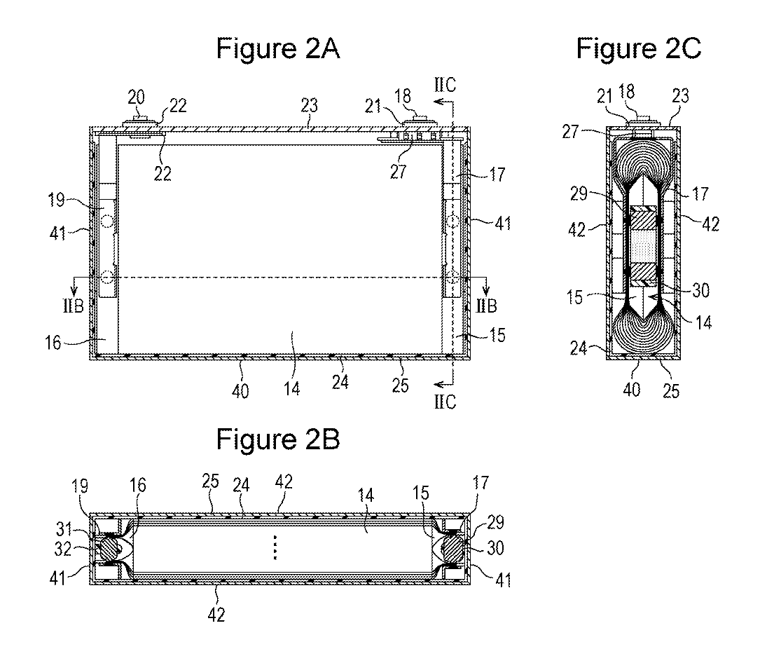

The plurality of layers of the positive-electrode-substrate exposed portion 15 are formed as illustrated in FIG. 4 and electrically connected to a positive electrode terminal 18 through a positive electrode current collector 17 (see FIG. 2A). The plurality of layers of the negative-electrode-substrate exposed portion 16 are formed as illustrated in FIG. 4 and electrically connected to a negative electrode terminal 20 through a negative electrode current collector 19 (see FIG. 2A). As illustrated in FIG. 2A, a current cutoff mechanism 27 that operates when gas pressure in the battery case 45 increases to or above a predetermined value is preferably disposed between the positive electrode current collector 17 and the positive electrode terminal 18, which will not be fully described.

As illustrated in FIGS. 1A, 1B, and 2A, the positive electrode terminal 18 and the negative electrode terminal 20 are fixed to the sealing plate 23 through insulating members 21 and 22, respectively. The sealing plate 23 has a gas exhausting valve 28 that opens when the gas pressure in the battery case 45 increases above the working pressure of the current cutoff mechanism 27. The positive electrode current collector 17, the positive electrode terminal 18, and the sealing plate 23 are individually made of aluminum or an aluminum alloy, and the negative electrode current collector 19 and the negative electrode terminal 20 are individually made of copper or a copper alloy. As illustrated in FIG. 2C, the flat wound electrode assembly 14 is covered except a sealing-plate-23 side by an electrically insulative insulating sheet (resin sheet) 24 and inserted into the prismatic outer body 25 that has an opening on one side.

As illustrated in FIGS. 2B and 2C, on the positive-electrode-plate-11 side, the plurality of layers of the positive-electrode-substrate exposed portion 15 stacked by winding are divided into two parts in a thickness direction, and a positive electrode intermediate member 30 is disposed therebetween. The positive electrode intermediate member 30 is made of a resin material and holds at least one positive electrode conductive member 29, for example, two positive electrode conductive members 29. The positive electrode conductive member 29 has, for example, a columnar shape, and truncated conical projecting portions serving as projections are formed on both sides of the positive electrode conductive member 29 so that the truncated conical projecting portions oppose the stacked positive-electrode-substrate exposed portion 15.

On the negative-electrode-plate-12 side, the plurality of layers of the negative-electrode-substrate exposed portion 16 that are stacked by winding are divided into two parts in the thickness direction, and a negative electrode intermediate member 32 is disposed therebetween. The negative electrode intermediate member 32 is made of a resin material and holds at least one negative electrode conductive member 31, for example, two negative electrode conductive members 31. The negative electrode conductive member 31 has, for example, a columnar shape, and truncated conical projecting portions serving as projections are formed on both sides of the negative electrode conductive member 31 so that the truncated conical projecting portions oppose the stacked negative-electrode-substrate exposed portion 16.

The positive electrode intermediate member 30 and the negative electrode intermediate member 32 are not essential and may therefore be omitted. The positive electrode conductive member 29 and the negative electrode conductive member 31 are also not essential and may therefore be omitted.

The positive electrode conductive member 29 and the layers of the positive-electrode-substrate exposed portion 15 gathered and disposed on both sides in an extending direction of the positive electrode conductive member 29 are electrically connected to each other by, for example, resistance welding. The gathered layers of the positive-electrode-substrate exposed portion 15 and the positive electrode current collector 17 disposed on an outer side of the positive-electrode-substrate exposed portion 15 in a depth direction of the battery case 45 are also electrically connected to each other by, for example, resistance welding. Similarly, the negative electrode conductive member 31 and the layers of the negative-electrode-substrate exposed portion 16 gathered and disposed on both sides of the negative electrode conductive member 31 are electrically connected to each other by, for example, resistance welding. The gathered layers of the negative-electrode-substrate exposed portion 16 and the negative electrode current collector 19 disposed on an outer side of the negative-electrode-substrate exposed portion 16 in the depth direction of the battery case 45 are also electrically connected to each other by, for example, resistance welding. The end portion of the positive electrode current collector 17 on a side opposite to the positive-electrode-substrate-exposed-portion-15 side is electrically connected to the positive electrode terminal 18, and the end portion of the negative electrode current collector 19 on a side opposite to the negative-electrode-substrate-exposed-portion-16 side is electrically connected to the negative electrode terminal 20. As a result, the positive-electrode-substrate exposed portion 15 is electrically connected to the positive electrode terminal 18, and the negative-electrode-substrate exposed portion 16 is electrically connected to the negative electrode terminal 20.

The wound electrode assembly 14, the positive electrode intermediate member 30, the negative electrode intermediate member 32, the positive electrode conductive member 29, and the negative electrode conductive member 31 are joined by resistance welding and formed into an integral structure. The positive electrode conductive member 29 is preferably made of aluminum or an aluminum alloy that is the material used for the positive electrode substrate, and the negative electrode conductive member 31 is preferably made of copper or a copper alloy that is the material used for the negative electrode substrate. The shapes of the positive electrode conductive member 29 and the negative electrode conductive member 31 may be the same or different.

In an example described here, the positive-electrode-substrate exposed portion 15 and the positive electrode current collector 17 are connected to each other by resistance welding, and the negative-electrode-substrate exposed portion 16 and the negative electrode current collector 19 are connected to each other by resistance welding. However, laser welding or ultrasonic welding may be employed. The positive electrode intermediate member 30 and the negative electrode intermediate member 32 are not necessarily used.

As illustrated in FIG. 1A, an electrolyte injection opening 26 is made in the sealing plate 23. The wound electrode assembly 14 to which the positive electrode current collector 17, the negative electrode current collector 19, the sealing plate 23, and the like have been attached is disposed in the prismatic outer body 25. The wound electrode assembly 14 is preferably inserted into the prismatic outer body 25 while being disposed in the insulating sheet 24 formed into a box or a bag. Subsequently a portion at which the sealing plate 23 and the prismatic outer body 25 are fitted to each other is laser welded, and a nonaqueous electrolyte is then injected through the electrolyte injection opening 26. Then, sealing the electrolyte injection opening 26 forms the prismatic secondary battery 10. The electrolyte injection opening 26 is sealed, for example, by using a blind rivet or by welding.

The prismatic secondary battery 10 is used alone or the plurality of prismatic secondary batteries 10 are connected to each other in series, parallel, or a combination of both series and parallel and used as a battery pack. The prismatic secondary batteries 10 are preferably bound so that a pressing force is applied to the second side surfaces 42 of the prismatic outer body 25 of each prismatic secondary battery 10 in the battery pack. When the plurality of prismatic secondary batteries 10 are connected to each other in series or parallel and used for vehicles and the like, the prismatic secondary batteries 10 each preferably include a positive electrode external terminal and a negative electrode external terminal additionally and are connected to each other using busbars. The battery pack preferably has a structure in which the plurality of prismatic secondary batteries 10 are arranged so that the second side surfaces 42 of the prismatic secondary batteries 10 are parallel to each other. In such a structure, endplates are disposed at both ends of the battery pack and clamped to each other by using bind bars, thereby binding the plurality of prismatic secondary batteries 10. The terminals of the adjacent prismatic secondary batteries 10 are connected to each other by using the busbars.

A structure in which the wound electrode assembly 14 is disposed so that the winding axis is parallel to the bottom portion 40 of the prismatic outer body 25 has been described; however, the wound electrode assembly may be disposed so that the winding axis is perpendicular to the bottom portion 40 of the prismatic outer body 25. A positive electrode active material usable in the prismatic secondary battery that can be produced by the method according to the present disclosure is preferably a lithium transition metal composite oxide. For example, compounds that can occlude and release lithium ions reversibly can be appropriately selected and used. As such positive electrode active materials, any one or combination of LiMn₂O₄, LiFePO₄, and lithium transition metal composite oxides that can be expressed as LiMO₂ (M represents at least one of Co, Ni, and Mn) and occlude and release the lithium ions reversibly may be used. Examples of LiMO₂ include LiCoO₂, LiNiO₂, LiNi_{y}Co_{1-y}O₂ (y=0.01-0.99), LiMnO₂, and LiCoₓMn_{y}Ni_{z}O₂ (x+y+z=1). Furthermore, lithium cobalt composite oxides including different kinds of metal elements, such as zirconium, magnesium, aluminum, and tungsten may also be used.

The solvent for the nonaqueous electrolyte is not particularly limited and solvents that have been commonly used for nonaqueous electrolyte secondary batteries may be used. Examples of the solvents include cyclic carbonates, such as ethylene carbonate (EC), propylene carbonate (PC), butylene carbonate, and vinylene carbonate (VC); chain carbonates, such as dimethyl carbonate (DMC), methyl ethyl carbonate (MEC), and diethyl carbonate (DEC); ester-containing compounds, such as methyl acetate, ethyl acetate, propyl acetate, methyl propionate, ethyl propionate, and γ-butyrolactone; sulfo-containing compounds, such as propanesultone, ether-containing compounds, such as 1,2-dimethoxyethane, 1,2-diethoxyethane, tetrahydrofuran, 1,2-dioxane, 1,4-dioxane, and 2-methyltetrahydrofuran; nitrile-containing compounds, such as butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile; and amide-containing compounds, such as dimethylformamide. In particular, solvents prepared by substituting some of hydrogen atoms of the above compounds with fluorine atoms are preferably used. These solvents may be used alone or in combination of two or more thereof. In particular, solvents containing cyclic carbonates and chain carbonates in a combined manner and solvents prepared by further adding small amounts of nitrile-containing compounds or ether-containing compounds to the solvents are preferably used.

An ionic liquid may also be used as a nonaqueous solvent of the nonaqueous electrolyte, and cation species and anion species of the ionic liquid are not particularly limited. However, from the viewpoint of low viscosity, electrochemical stability, and hydrophobicity, a cation such as a pyridinium cation, an imidazolium cation, or a quaternary ammonium and an anion such as a fluorine-containing imide anion are particularly preferably combined with each other.

With regard to solutes for the nonaqueous electrolyte, publicly known lithium salts that have been typically used for nonaqueous electrolyte secondary batteries may be used. Such lithium salts may include at least one of elements P, B, F, O, S, N, and Cl. Specific examples of such lithium salts include LiPF₆, LiBF₄, LiCF₃SO₃, LiN(FSO₂)₂, LiN(CF₃SO₂)₂, LiN(C₂F₅SO₂)₂, LiN(CF₃SO₂)(C₄F₉SO₂), LiC(C₂F₅SO₂)₃, LiAsF₆, LiClO₄, LiPF₂O₂, and a mixture thereof. In particular, LiPF₆ is preferably used to improve the high-rate charge-discharge characteristics and durability of the nonaqueous electrolyte secondary battery.

The solutes described above may be used either alone or as a mixture of two or more thereof. The concentration of the solute is not particularly limited, but is preferably 0.8 to 1.7 mol per liter of the nonaqueous electrolyte. In uses in which a large current needs to be discharged, the concentration of the solute is preferably 1.0 to 1.6 mol per liter of the nonaqueous electrolyte.

In the nonaqueous electrolyte secondary battery in one aspect of the present disclosure, the negative electrode active material used for the negative electrode is not particularly limited provided that the negative electrode active material can occlude and release lithium ions reversibly. The negative electrode active material may be, for example, a carbon material, a silicon material, lithium metal, a metal or alloy material that is alloyed with lithium, or a metal oxide. From the viewpoint of material costs, the negative electrode active material is preferably a carbon material, such as natural graphite, synthetic graphite, a mesophase pitch-based carbon fiber (MCF), mesocarbon microbeads (MCMB), coke, and hard carbon. In particular, from the viewpoint of improving the high-rate charge-discharge characteristics, a carbon material such as a graphite material covered by low crystalline carbon is preferably used as the negative electrode active material. The mass ratio of the graphite material to the total mass of the negative electrode active material of the wound electrode assembly 14 is preferably 70% or more, more preferably 80% or more, and most preferably 90% or more.

Hereinafter, Examples according to the present disclosure will be fully described with reference to Table 1. Table 1 shows whether electrode plates and a separator of each prismatic secondary battery break in a cycle test in which a plurality of prismatic secondary batteries that each have a structure illustrated in FIGS. 1A to 4 and is produced to have a different separator are tested for durability. The present disclosure is not limited to Examples.

TABLE 1

| | Comparative | Comparative | Comparative | |
|---|---|---|---|---|
| | Example 1 | Example 2 | Example 3 | Example |
| Number of stacked layers of | 66 | 66 | 66 | 66 |
| positive electrode | | | | |
| Type of separator | layered by wet | layered by wet | three layers by | nine layers by |
| | process | process | dry process | dry process |
| Separator thickness (μm) | 12 | 12 | 12 | 12 |
| Thickness of wound electrode | 22.65 | 22.65 | 22.65 | 22.65 |
| assembly (mm) | | | | |
| Ratio of separator thickness (%) | 7 | 7 | 7 | 7 |
| Breaking strength of separator in | 150 | 150 | 206 | 240 |
| winding direction (MPa) | | | | |
| Breaking elongation of separator | 60 | 140 | 60 | 50 |
| in winding direction (%) | | | | |
| Local breaking strength of | 22.2 | 14.0 | 29.5 | 33.2 |
| separator in winding direction | | | | |
| (N/cm) | | | | |
| Local breaking elongation of | 1.60 | 1.05 | 1.72 | 1.94 |
| separator in winding direction | | | | |
| (mm) | | | | |
| Local breaking strength/separator | 1.85 | 1.15 | 2.46 | 2.77 |
| thickness | | | | |
| Local breaking | 0.13 | 0.09 | 0.14 | 0.16 |
| elongation/separator thickness | | | | |
| Breakage of electrode plate (after | yes | yes | yes | yes |
| cycle test) | | | | |
| Breakage of separator (after cycle | yes | yes | yes | no |
| test) | | | | |

### Structures and Properties of Prismatic Secondary Batteries in Comparative Examples and Example

### Secondary Battery in Comparative Example 1

The following substances were used for a positive electrode mixture layer, a negative electrode mixture layer, and a nonaqueous electrolyte. Specifically, the positive electrode mixture layer contained LiNi_{0.35}CO_{0.35}Mn_{0.30}O₂ as a positive electrode active material, carbon black as an electrical conducting material, and polyvinylidene fluoride (PVdF) as a binder in a mass ratio of 92:5:3. The negative electrode mixture layer contained graphite as a negative electrode active material, carboxymethylcellulose (CMC) as a thickener, styrene-butadiene rubber (SBR) as a binder in a mass ratio of 98:1:1. The nonaqueous electrolyte was produced as follows. Ethylene carbonate (EC), ethyl methyl carbonate (EMC), and diethyl carbonate (DEC) were mixed in a volume ratio of 3:3:4 (25° C., 1 atmosphere) to give a mixed solvent. LiPF₆ was added to the mixed solvent so that the LiPF₆ concentration in the mixed solvent was 1 mol/L. Vinylene carbonate (VC) was further added to give the nonaqueous electrolyte so that the amount of vinylene carbonate added was 0.3% of the total mass of the nonaqueous electrolyte.

A wound electrode assembly having a thickness of 22.65 mm and of which the number of stacked layers of the positive electrode plate is 66 (number of windings is 33) was used. A layered separator produced by the wet process and having a thickness of 12 μm was used. Specifically, the separator was produced by the wet process in which a microporous film constituting the separator was produced by preparing a uniform solution by mixing polymers and a solvent at a high temperature, forming the uniform solution into a film by a T-die method, extracting and removing the solvent from the film using another volatile solvent, and stretching the film. The separator had a structure that did not include an interface and included a polyethylene portion in the center in the thickness direction and a mixture portion containing polyethylene and polypropylene on each side of the polyethylene portion in the thickness direction. In the wound electrode assembly, the ratio of the total thickness of the separator to the thickness of the wound electrode assembly (ratio of separator thickness) was 7%. The total thickness of the separator is calculated by multiplying the thickness of a single layer of the separator by the number of stacked layers of the separator.

The separator had a breaking strength of 150 MPa in a winding direction of the separator and a breaking elongation of 60% in the winding direction of the separator. These values were measured in conformity with measurement of typical breaking elongation and breaking strength of separators, specifically in conformity with JIS K-7127. FIG. 8 illustrates a plan view of a test specimen 55 used in this measurement. The breaking strength and the breaking elongation were measured in such a manner that tensile stress denoted by an arrow is applied to the test specimen 55 in a Y direction indicating an extending direction. As illustrated in FIG. 8, the test specimen 55 had a thick portion 55a that is thick in a X direction on both sides in the Y direction and a thin portion 55b that is thin in the X direction in the center in the Y direction. In this method, while the tensile stress was being applied, the test specimen 55 was allowed to contract in the X direction, in particularly, the thin portion 55b that was thin in the X direction contracted considerably in the X direction.

The separator had a local breaking strength of 22.2 N/cm in a winding direction of the separator and a local breaking strength/separator thickness ratio of the separator of 1.85, as described with reference to FIGS. 5A, 5B, 5C and 7. The separator also had a local breaking elongation of 1.60 mm in the winding direction of the separator and a local breaking elongation/separator thickness ratio of the separator of 0.13, as described with reference to FIGS. 5A to 6.

### Secondary Battery in Comparative Example 2

A secondary battery was produced in the same manner as in Comparative Example 1, except that the separator had a breaking elongation of 140% in a winding direction thereof, a local breaking strength of 14.0 N/cm in the winding direction thereof, a local breaking strength/separator thickness ratio of 1.15, a local breaking elongation of 1.05 mm in the winding direction thereof, and a local breaking elongation/separator thickness ratio of 0.09.

### Secondary Battery in Comparative Example 3

A secondary battery was produced in the same manner as in Comparative Example 1, except that the separator had a breaking strength of 206 MPa in the winding direction thereof, a local breaking strength of 29.5 N/cm in the winding direction thereof, a local breaking strength/separator thickness ratio of 2.46, a local breaking elongation of 1.72 mm in the winding direction thereof, and a local breaking elongation/separator thickness ratio of 0.14. The separator was a three-layered separator and produced by the dry process. Specifically, the separator was produced as follows. A molten polymer was extruded from a T-die, formed into a film at a high draft ratio, and then subjected to heat treatment so that a crystal structure with high regularity was formed. Then, using either a process in which the crystal interfaces were delaminated by stretching the film at a high temperature after stretching the film at a low temperature so as to form gap portions between lamellae, thereby forming a porous structure or a process in which a sheet consisting of three layers in which polypropylene layers sandwiched a polyethylene layer therebetween vertically was stretched in one direction so as to form openings (micropores) at interfaces between different polymers, a microporous film was formed and used as the separator.

### Secondary Battery in Example

A secondary battery was produced in the same manner as in Comparative Example 1, except that the separator had a breaking strength of 240 MPa in the winding direction thereof, a breaking elongation of 50% in the winding direction thereof, a local breaking strength of 33.2 N/cm in the winding direction thereof, a local breaking strength/separator thickness ratio of 2.77, a local breaking elongation of 1.94 mm in the winding direction thereof, and a local breaking elongation/separator thickness ratio of 0.16.

The separator was a nine-layered separator and produced by the dry process. Specifically, the separator was produced as follows. A molten polymer was extruded from a T-die and formed into a film at a high draft ratio, and the film was then subjected to heat treatment so that a crystal structure with high regularity is formed. Then, using either a process in which by stretching the film at a high temperature after stretching the film at a low temperature, the crystal interfaces were delaminated so as to form gap portions between lamellae, thereby producing a porous structure or a process in which a sheet consisting of nine layers in which three-layered polypropylene layers sandwiched a three-layered polyethylene layer therebetween vertically was stretched in one direction so as to form openings (micropores) at interfaces between different polymers, a microporous film was formed and used as the separator.

### Evaluation of Prismatic Secondary Battery

The produced batteries were subjected to a cycle test and then disassembled, and whether the electrode plates had broken was visually determined. Whether the separators had broken was visually determined at the same time. The cycle test was performed at an environmental temperature of 45° C. The batteries were charged with a constant current of 1 It until the battery voltage reached 4.25 V. After the battery voltage reached 4.25 V, the batteries were charged with a constant voltage of 4.25 V until the current decreased to 1/20 It. Then the batteries were discharged with a constant current of 1 It until the battery voltage decreased to 2.5 V. This charge-discharge cycle was repeatedly performed 1500 times.

### Result of Evaluation of Prismatic Secondary Battery

The local breaking strength/separator thickness ratios in Comparative examples 1, 2, and 3 were 1.85, 1.15, and 2.46, respectively. The secondary batteries having local breaking strength/separator thickness ratios of 2.46 or less in Comparative examples 1 to 3 were confirmed to have breakages of the electrode plates and the separators. The local breaking elongation/separator thickness ratios in Comparative examples 1, 2, and 3 were 0.13, 0.09, and 0.14, respectively. The secondary batteries having local breaking elongation/separator thickness ratios of 0.14 or less in Comparative examples 1 to 3 were confirmed to have breakages of the electrode plates and the separators.

In contrast, the battery in Example having a local breaking strength/separator thickness ratio of 2.77 and a local breaking elongation/separator thickness ratio of 0.16 was confirmed to have breakages of the electrode plates but not a breakage of the separator.

In the batteries in Comparative examples 1 to 3, the breaking elongation of each separator, which is typically used as an indicator of elongation of materials based on JIS, is higher than the breaking elongation based on JIS of the separator of the battery in Example. However, the separators of the batteries used in Comparative examples 1 to 3 were confirmed to have breakages.

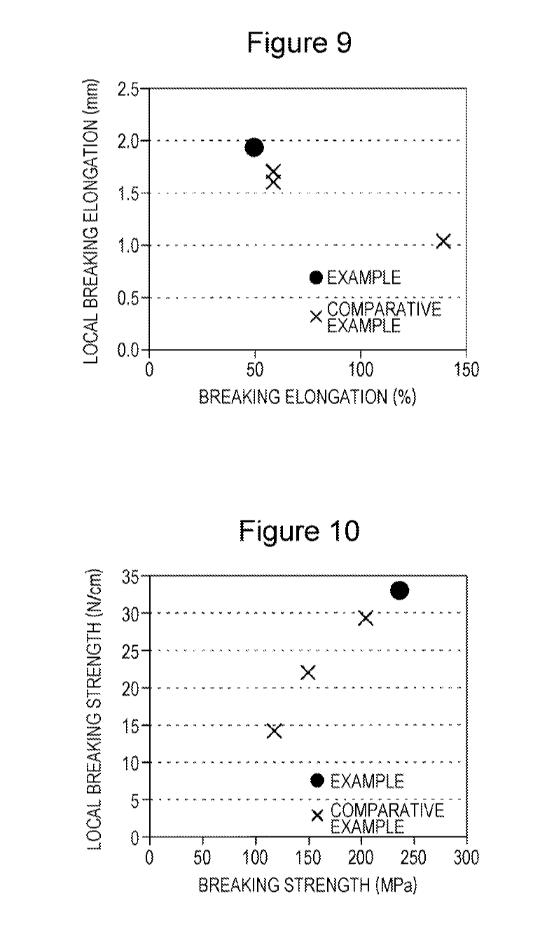

Specifically, referring to FIG. 10, in other words, referring to a graph in which the measuring points of Comparative examples 1 to 3 and Example are illustrated in a two-dimensional plane, where the x-axis parameter denotes the typical breaking strength and the y-axis parameter denotes the local breaking strength, the separator of the battery in Example had the highest typical breaking strength and the highest local breaking strength. However, referring to FIG. 9, in other words, referring to a graph in which the measuring points of Comparative examples 1 to 3 and Example are illustrated in a two-dimensional plane, where the x-axis parameter denotes the typical breaking elongation and the y-axis parameter denotes the local breaking elongation, the separator of the battery in Example had the lowest typical breaking elongation, specifically, a breaking elongation of 50%, which was considerably lower than a breaking elongation of 140% of the separator of the battery in Comparative example 2. Nevertheless, the separator in Comparative example 2 was confirmed to have a breakage whereas the separator in Example did not have a breakage.

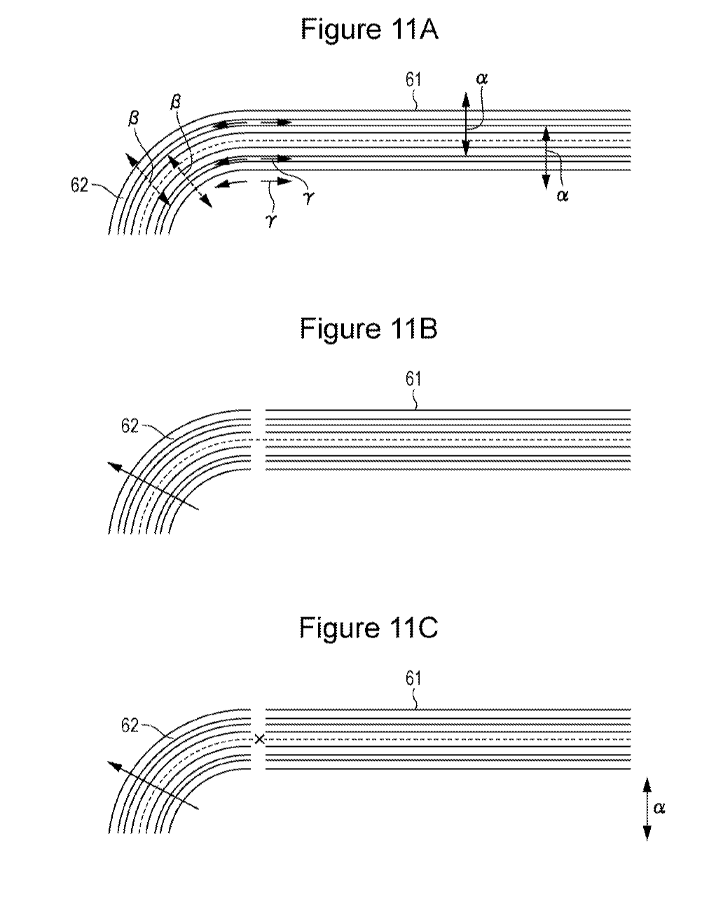

In further consideration, the battery in Example had the lowest breaking elongation while having the largest local breaking elongation/separator thickness ratio of the four batteries in Comparative examples 1 to 3 and Example. With reference to FIGS. 11A to 11C, the reason why the typical breaking elongation is not appropriate and the local breaking elongation is appropriate as an indicator of ease of breakage of the separator will be described.

FIGS. 11A to 11C each illustrate a schematic cross section of the outermost periphery of the wound electrode assembly, the cross section being perpendicular to the winding axis of the wound electrode assembly. FIGS. 11A to 11C also illustrate a breaking mechanism of the positive and negative electrode plates and the separator in the battery case, as considered by the present inventors. As illustrated in FIG. 11A, the cross section perpendicular to the winding axis of the flat wound electrode assembly has a track shape. The flat wound electrode assembly is restricted from moving in the battery case in such a manner that a flat portion 61 is pressed against an inner surface of each end of the battery case in the thickness direction denoted by the a direction in FIG. 11A. Therefore, the wound electrode assembly is unlikely to expand in the a direction even if the active material layers expand during the charge-discharge of the battery.

However, a space exists between a curved portion 62 and a wall of the battery case, so that the wound electrode assembly may expand in a radial direction illustrated by arrow β. As a result, the tensile stress illustrated by arrow γ is generated around a boundary of the flat portion 61 and the curved portion 62. Therefore, when an amount of the active material is increased to increase the battery capacity, the large tensile stress is generated around the boundary. It is considered that first, the electrode plate, which extends less and is easier to break than the separator, breaks at the outer periphery where the tensile stress is particularly large, as illustrated in FIG. 11B, and then the separator breaks after extending to the limit as illustrated in FIG. 11C. At this point, the separator is pressed against the positive and negative electrode plates in the thickness direction in the wound electrode assembly, and a surface pressure is applied to the separator in the thickness direction. Therefore, the expansion and contraction of the separator is restricted in the width direction (direction parallel to the winding axis) by the surface pressure. Consequently, it is considered that the typical breaking elongation that allows large expansion and contraction in the width direction is not appropriate as an indicator of the ease of breakage of the separator; rather, the local breaking elongation that does not allow expansion and contraction in the width direction is appropriate.

The above-mentioned results revealed the following fact. Using a value obtained by dividing local breaking strength by separator thickness and a value obtained by dividing local breaking elongation by separator thickness as indicators of ease of breakage of a separator used under a special circumstance such as in a battery case, the possibility of breakage of the separator can be correctly determined.

When a value obtained by dividing local breaking strength by separator thickness is higher than 2.46, breakage of a separator can be suppressed, and furthermore, when the value is 2.77 or higher, breakage of a separator can be substantially prevented. When a value obtained by dividing local breaking elongation by separator thickness is higher than 0.14, breakage of a separator can be suppressed, and furthermore, when the value is 0.16 or higher, breakage of a separator can be substantially prevented.

As described above, a separator preferably includes four or more layers layered in the thickness direction and three or more interfaces while each of the interfaces exists between two layers adjacent to each other in the thickness direction because the strength of the separator increases in response to an increasing number of interfaces, and thus the separator is unlikely to break. A separator preferably includes five or more interfaces while each of the interfaces exists between two layers adjacent to each other in the thickness direction because the strength of the separator further increases. The separator most preferably includes eight or more interfaces because the strength much further increases.

In a large-capacity battery in which the thickness of the separator is 19 μm or less and the thickness of the active material layer is increased accordingly, the electrode assembly expands considerably while the battery is being charged and discharged, thereby increasing the possibility of breakage of the separator. Therefore, if such a large-capacity battery has the structure according to the present disclosure, the advantage of the present disclosure in which the separator is unlikely to break is fully realized.

Graphite that can be employed as a negative electrode active material expands and contracts considerably while a battery is being charged and discharged, thereby contributing to expansion and contraction of an electrode assembly largely. Therefore, in a case in which the negative electrode active material of the negative electrode plate includes 70% by mass of graphite relative to the total mass of the negative electrode active material, the electrode assembly expands considerably. Therefore, if such a battery has the structure according to the present disclosure, the advantage of the present disclosure in which the separator is unlikely to break is fully achieved.

Even if the positive electrode plate or the negative electrode plate breaks due to expansion of the wound electrode assembly, a short circuit between the positive electrode plate and the negative electrode plate can be prevented provided that the separator placed between the positive electrode plate and the negative electrode plate does not break, thereby ensuring safety.

The positive electrode substrate is preferably a metal foil, such as an aluminum foil or an aluminum alloy foil. The positive electrode substrate preferably has a thickness of 10 μm to 20 μm, more preferably 12 μm to 18 μm. The positive electrode active material layer formed on a single side of the positive electrode substrate preferably has a thickness of 50 μm to 150 μm, more preferably 50 μm to 100 μm, further more preferably 60 μm to 90 μm.

The negative electrode substrate is preferably a metal foil, such as a copper foil or a copper alloy foil. The negative electrode substrate preferably has a thickness of 6 μm to 15 μm, more preferably 8 μm to 12 μm. The negative electrode active material layer formed on a single side of the negative electrode substrate preferably has a thickness of 50 μm to 150 μm, more preferably 50 μm to 90 μm, further more preferably 60 μm to 80 μm.

The positive electrode active material layer preferably has a packing density of 2.5 g/cm³ to 3.2 g/cm³, more preferably 2.7 g/cm³ to 3.0 g/cm³. The negative electrode active material layer preferably has a packing density of 1.3 g/cm³ to 1.7 g/cm³, more preferably 1.4 g/cm³ to 1.6 g/cm³.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A nonaqueous electrolyte secondary battery comprising:
a flat wound electrode assembly formed by winding a positive electrode plate and a negative electrode plate together with a separator interposed therebetween;
an outer case including an outer body in which the wound electrode assembly is disposed and a sealing body that seals an opening of the outer body;
a positive electrode current collector electrically connected to the positive electrode plate;
a negative electrode current collector electrically connected to the negative electrode plate; and
a nonaqueous electrolyte disposed in the outer case,
wherein a number of stacked layers of the positive electrode plate in the wound electrode assembly is 50 or more,
the separator has a total thickness of 10% or less of a thickness of the wound electrode assembly in a thickness direction of the wound electrode assembly,
with regard to a first test specimen, a second test specimen, and a third test specimen, all of which are made of a material identical to a material for the separator and have a thickness identical to a thickness of the separator and a width of 40 mm, the first test specimen having a length of 1 mm in a winding direction, the second test specimen having a length of 3 mm in the winding direction and only length being a difference between the first and second specimens, and the third test specimen having a length of 5 mm in the winding direction and only length being a difference between the first and third specimens, in a test in which a length (mm) of each of the three test specimens is measured to obtain three measuring points at which the test specimen breaks while being pulled in the winding direction, in a two-dimensional plane where one parameter denotes a length of the test specimen in the winding direction before the test and another parameter denotes a length measured when the test specimen breaks while being pulled in the winding direction, when an intersection point of a linear function obtained by a least squares method in accordance with the three measuring points of the first to third test specimens and an axis of the other parameter is defined as a local breaking elongation of the separator, a value obtained by dividing the local breaking elongation of the separator by the thickness of the separator is 0.16 or more, and
with regard to the first to third test specimens, in a test in which a strength (N/cm) of each of the three test specimens is measured to obtain three measuring points at which the test specimen breaks while being pulled in the winding direction, in a two-dimensional plane where one parameter denotes a length of the test specimen in the winding direction before the test and another parameter denotes a strength measured when the test specimen breaks while being pulled in the winding direction, when an intersection point of a linear function obtained by the least squares method in accordance with the three measuring points of the first to third test specimens and an axis of the parameter denoting the strength measured when the test specimen breaks is defined as a local breaking strength of the separator, a value obtained by dividing the local breaking strength of the separator by the thickness of the separator is 2.77 or more.

2. The nonaqueous electrolyte secondary battery according to claim 1, wherein the separator includes at least four layers in a thickness direction of the separator.

3. The nonaqueous electrolyte secondary battery according to claim 1, wherein the separator has a thickness of 19 μm or less.

4. The nonaqueous electrolyte secondary battery according to claim 1, wherein a negative electrode active material of the negative electrode plate contains 70% by mass or more of graphite relative to a total mass of the negative electrode active material.
